(19) United States
(12) Patent Application Publication
(10) Pub. No.: US 2012/0193849 A1
(43) Pub. Date: Aug. 2, 2012

(54) SUSPENSION DEVICE FOR VEHICLES

(75) Inventor: Walter Runkel, Leubsdorf (DE)

(73) Assignee: Hemscheidt Fahrwerktechnik GmbH & Co. KG, Haan-Gruiten (DE)

(21) Appl. No.: 13/331,117

(22) Filed: Dec. 20, 2011

(30) Foreign Application Priority Data
Jan. 27, 2011 (EP) 11152393.2

(51) Int. Cl. B60G 15/12

(52) U.S. Cl. 267/217

(57) ABSTRACT

A suspension system (1) for a motor vehicle having a telescopic spring cylinder (2), having two spring stages (A, B), namely one main cylinder (8) as a first spring stage (A) and an auxiliary cylinder (10) as a second spring stage (B). An auxiliary piston (26) with an auxiliary piston rod (28) is displaced in the auxiliary cylinder (10). Inside the auxiliary cylinder (10), the auxiliary piston (26) is acted upon by a spring pressure (p2) for decompression, which is generated by a pneumatic pressure medium (PM) inside the auxiliary cylinder (10). The auxiliary piston (26) is indirectly acted upon by the spring pressure (p2) via an hydraulic medium (HM) inside the auxiliary cylinder (10). Peripheral seals (30, 38) arranged between the auxiliary cylinder (10) and the auxiliary piston (26), and the auxiliary piston rod (28) are separated from the pneumatic pressure medium (PM) via the hydraulic medium (HM).

### CROSS-REFERENCE TO RELATED APPLICATIONS

This application claims priority to European Application No. 11152393.2, filed Jan. 27, 2011.

### FIELD OF THE INVENTION

The present invention relates to a suspension system for a weight-bearing and resilient wheel support in a motor vehicle, consisting of a linear telescopic spring cylinder of variable length for compression and decompression purposes, having two spring stages arranged longitudinally in a row (in series), namely one main cylinder as a first spring stage, and an additional cylinder as a second spring stage, an auxiliary piston being guided outward with an auxiliary piston rod, and the auxiliary piston being acted upon by a spring pressure generated by an elastically compressible, pneumatic pressure medium contained at least proportionally in the auxiliary cylinder, for decompression inside the auxiliary cylinder.

### BACKGROUND OF THE INVENTION

A suspension system of the above mentioned generic kind has been disclosed in document EP 1 745 951 B1. In this known embodiment, the auxiliary cylinder forming the second spring stage is arranged at the free end of the piston rod of the telescopic main cylinder forming the first spring stage such that the piston rod is telescopically variable in length. In this case, the auxiliary cylinder is directly acted upon by the pressure of a pneumatic spring medium. Nitrogen is at present frequently used as a pneumatic spring medium, which is why very costly gas seals are required for sealing. In addition, such seals cause high friction during the suspension movements between the parts moving relative to one another.

The object underlying the present invention is to provide a suspension system of the kind described above, which offers improved characteristics of use with simple and therefore cost-effective construction.

According to the present invention, the auxiliary piston is indirectly acted upon by spring pressure via an hydraulic medium situated inside the auxiliary pressure medium in addition to the pneumatic medium such that peripheral seals arranged between the auxiliary cylinder and firstly, the auxiliary piston and secondly, the additional piston rod, are separated from the pneumatic pressure medium via the hydraulic medium. In other words, this means that all seals are only acted upon by the hydraulic medium. The peripheral seals of the prior art required gas seals which are more complex than those for liquid sealing and can thus have a much simpler design. This feature alone contributes to reducing the friction in the sealing area. In addition, the friction is still largely reduced in that the seal area is lubricated by the action of the hydraulic medium. The constructively simplified seals thus also result in considerably improved characteristics of use of the suspension system according to the present invention.

In a preferred embodiment of the invention, the first spring stage is arranged in an upper vertical area and the second spring stage in a lower vertical area in the conventional mounting position of the spring cylinder. In this case, a filling pipe is arranged inside the auxiliary cylinder and an upper end of the pipe extends centrically and radially through the hydraulic medium situated in a lower area due to gravity and extends into the area of the pneumatic pressure medium situated above the hydraulic medium.

A lower end of the filling pipe merges into a filling connector which is provided in the lower area of the spring cylinder. The filling connector conveniently has a filling valve similar to the compressed-air valve found on tires.

By means of this described advantageous embodiment, the pneumatic spring pressure can easily be adjusted by adding or releasing gas without hydraulic medium escaping while the gas is being released, and without the gas flowing freely through the hydraulic medium when the gas is added. After the mechanical production and mounting of the spring cylinder, the required volume of hydraulic medium can be filled in via the filling connector and the filling pipe before the pneumatic pressure medium is finally charged at the desired spring pressure. The pressure medium then acts directly, i.e. without a dividing element, such as a membrane or a freely moveable dividing piston, on the hydraulic medium and indirectly via the hydraulic medium on the auxiliary piston in its decompression direction so that compression against the spring force and decompression by the action of the spring force occur.

Additional benefits and advantages of the present invention will become apparent to those skilled in the art to which the present invention relates from the subsequent description of the preferred embodiment and the appended claims, taken in conjunction with the accompanying drawings.

### BRIEF DESCRIPTION OF THE DRAWINGS

The invention shall be explained in more detail with reference to preferred exemplary embodiments illustrated in the drawing. The figures show:

FIG. 1 shows a first embodiment of a suspension system according to the present invention showing an axial section of the components, namely in an exemplary suspension state of the spring stages,

FIG. 2 shows the suspension system according to FIG. 1 in a static position resulting from being loaded with a defined weight,

FIG. 3 shows the suspension system according to FIGS. 1 and 2 in a completely decompressed state from the static position according to FIG. 2,

FIG. 4 shows the suspension system according to FIGS. 1 to 3 in a completely compressed state from the static position according to FIG. 2, and

FIGS. 5 to 7 are illustrations analogous to FIGS. 2 to 4 of a second embodiment of the suspension system according to the present invention.

### DETAILED DESCRIPTION OF THE INVENTION

The same and/or functionally corresponding parts and components are always denoted with the same reference numerals in the different figures of the drawing.

With respect to the description below, it is expressly pointed out that the invention has not been restricted to the exemplary embodiments, and thus not to all or several characteristics or described combinations of characteristics; in fact, each individual partial characteristic of the/each exemplary embodiment can also be fundamental to the present invention independently of all other partial characteristics described above, as such or also in combination with any characteristic of another exemplary embodiment.

A suspension system 1, according to the present invention, consists of at least one linear telescopic spring cylinder 2 which is configured variable in length for compression and decompression purposes. Such a spring cylinder 2 is frequently also called “suspension strut”. The spring cylinder 2 is provided for a direct arrangement between a non-suspended (“unsprung”) mass, i.e. a motor vehicle wheel and/or axle, and a suspended (“sprung”) mass, a vehicle frame and/or bodywork. For this purpose, the spring cylinder 2 has appropriate mounting elements 4 and 6 at its opposite ends facing away from one another, which can be configured as so-called bearing eyes.

The spring cylinder 2 has a twofold telescopically variable length and consists of two spring stages A and B arranged longitudinally in a row, namely one main cylinder 8 as a first spring stage A, and an auxiliary cylinder 10 as a second spring stage B.

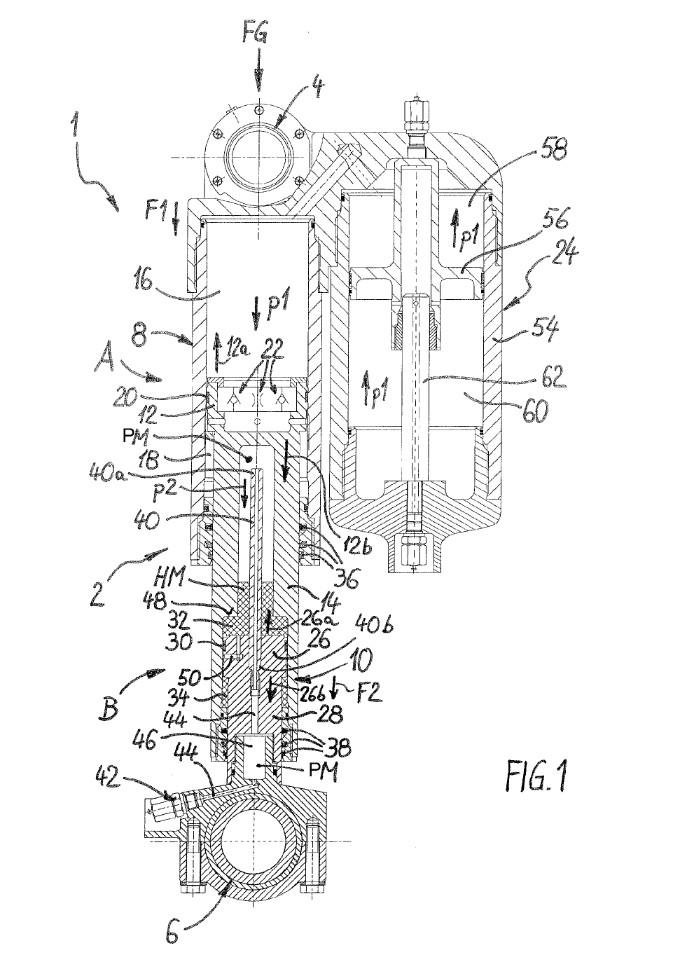

A main piston 12 for compression and decompression purposes is linearly displaceable in the main cylinder 8. The compression is shown with an arrow 12a in FIG. 1, and the decompression with an arrow 12b. The main piston 12 is connected to a main piston rod 14 which protrudes out peripherally sealed from the main cylinder 8. Inside the main cylinder 8, the main piston 12 separates two working chambers 16 and 18 filled with a hydraulic medium from one another, namely a working chamber 16 from an annular chamber enclosing the main piston rod 14. In order to separate the working chambers 16 and 18, the main piston 12 has a piston ring seal 20 on its outer periphery, which is in sealing contact with the inner wall of the main cylinder 8. In this case, the working chambers 16 and 18 are hydraulically connected to one another, in particular via a damping valve arrangement 22 of the main piston 12.

The main cylinder 8 can basically interact with a mechanical spring. In the illustrated, preferred embodiments, however, the main piston 12 is acted upon by a spring pressure p1 of a hydropneumatic pressure accumulator 24 for decompression purposes. For this purpose, the cylinder chamber 16 is hydraulically connected to the pressure accumulator. The spring pressure p1 generates a load capacity F1 of the main cylinder 8 by acting upon the effective piston surface according to the equation F=p·A.

With regard to the second spring stage B, an auxiliary piston 26 is similarly linearly displaceable in the auxiliary cylinder 10 for compression purposes (arrow 26a in FIG. 1) and for decompression purposes (arrow 26b). The auxiliary piston 26 is connected to a peripherally sealed, auxiliary piston rod 28 which protrudes outward from the auxiliary cylinder 10. The auxiliary piston 26 also has a piston ring seal 30 on its outer periphery so that the auxiliary piston 26 inside the auxiliary cylinder 10 divides two working chambers from one another, namely a cylinder chamber 32 from an annular chamber enclosing the auxiliary piston rod 28 (in particular, see FIG. 1).

Inside the auxiliary cylinder 10, the auxiliary piston 26 is now acted upon by a spring pressure p2 for decompression purposes. This spring pressure p2 is generated by an elastically compressible pneumatic pressure medium PM which, at least proportionally, is contained in the auxiliary cylinder 10. The spring pressure p2 generates a strength A2 in the decompression direction by acting upon the effective piston surface of the auxiliary piston 26 according to the equation F=p·A, compression taking place against this elastic force F2 and generating a decompression against this force F2.

It should still be mentioned at this point that peripheral seals 36 are provided in order to peripherally seal the main piston rod 14 protruding from the main cylinder 8, i.e. to seal an annular gap formed in the lead-through area between the main piston rod 14 and the main cylinder 8. Peripheral seals 38 are also similarly arranged between the auxiliary piston rod 28 and the auxiliary cylinder 10.

Accordingly, the present invention provides that at the second spring stage B acted upon by the pneumatic pressure medium PM the auxiliary piston 26 is indirectly acted upon by the spring pressure p2 via a hydraulic medium HM situated inside the auxiliary cylinder 10 in addition to the pneumatic pressure medium PM, such that all existing peripheral seals, namely on the one hand the piston seal 20, and on the other hand the peripheral seals 38, are separated from the pneumatic pressure medium PM via the hydraulic medium HM. As already mentioned above, according to the present invention, all seals 30 and, 38 are thus only acted upon by the hydraulic medium HM. And consequently, pressure sealing is simplified and the friction is reduced.

It should be mentioned that the arrangement and alignment of the spring stages A and B are arbitrary with reference to the vertical direction shown.

In the illustrated, preferred embodiments, however, the first spring stage A is arranged in an upper vertical area and the second spring stage B in a lower vertical area in the conventional mounting position of the spring cylinder 2 in a motor vehicle. In this case, the main cylinder is aligned such that the main piston rod 14 connected to the main piston 12 protrudes downward, the opposite, upper end of the main cylinder 8 having the upper mounting element 4.

It is further preferably provided that with regard to the second spring stage B, the auxiliary piston rod 28 connected to the auxiliary piston 26 also protrudes downward from the auxiliary cylinder 10. In this case, the auxiliary piston rod 28 is connected by its free to the lower mounting element 6.

This preferred embodiment has the advantage that at its free lower end, the main piston rod 14 can be connected to the auxiliary cylinder 10, or due to a hollow formation starting at the free lower end thereof, said main piston rod is designed as auxiliary cylinder 10 directly accommodating the auxiliary piston 26 with the auxiliary piston rod 28.

Alternatively, a respectively inverse alignment of the main cylinder 8 and/or auxiliary cylinder 10 would, of course, also be possible.

In another advantageous embodiment, a filling pipe 40 is arranged centrically inside the auxiliary cylinder 10 and an upper end 40a thereof extends axially through the hydraulic medium HM situated in a lower area due to gravity, and extends into the area of the pneumatic pressure medium PM situated above the hydraulic medium HM. A lower end 40b of the filling pipe 40 merges into a filling connector 42 which is arranged in the lower area of the spring cylinder 2, in particular in the area of the lower mounting element 6, and is conveniently provided with a filling connector 42. The auxiliary piston rod 28, and, if applicable, the auxiliary piston 26 have an inner filling channel 44 starting at the filling connector 42 and merging into the filling pipe 40 arranged on the side of the auxiliary piston 26.

A chamber-like expansion volume 46 can preferentially be provided in the area of this filling channel 44 to increase the total volume of the pneumatic pressure medium PM. In addition, an external auxiliary accumulator to increase the total volume of the pressure medium PM could also be connected via the filling connector 42. The total volume influences the spring characteristic of the pressure medium PM acting as a pneumatic spring.

In another advantageous embodiment, an annular step 48 is formed as a jounce bumper for the auxiliary piston 26 due to a reduction of the inner cross-section inside the auxiliary cylinder 10, beginning at the space accommodating the auxiliary piston 26. In this connection, the hydraulic medium HM is contained in the auxiliary cylinder at such a volume that the pneumatic pressure medium PM is mainly in the narrow area of the cylinder, apart from the chamber-like expansion volume 46 in the area of the filling channel 44.

According to the present invention, the auxiliary piston 26 is immersed in the hydraulic medium HM on both sides and thus both working chambers 32, 34 are hydraulically connected to one another. For this purpose, the first embodiment according to FIGS. 1 to 4 provides that the auxiliary piston 26 at least has a channel-like passage 50 for the hydraulic connection of the working chambers 32 and 34.

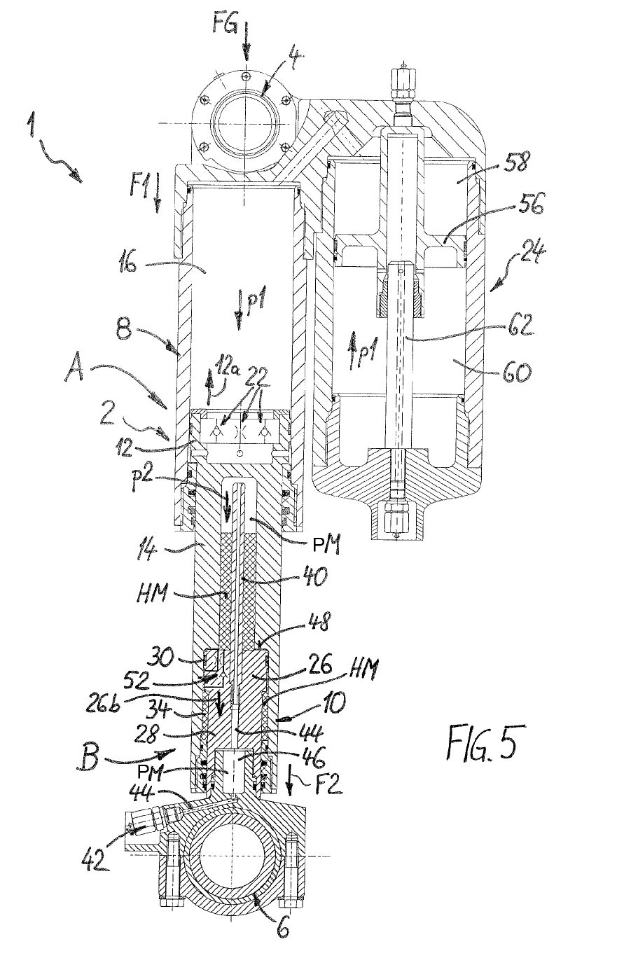

In the alternative embodiment according to FIGS. 5 to 7, the hydraulic connection between the working chambers 32 and 34 of the auxiliary cylinder 10 is made via a damping valve arrangement 52 of the auxiliary piston 26. Consequently, hydraulic damping in addition to the damping valve arrangement 22 of the first spring stage A is also generated. Otherwise, the second embodiment of FIGS. 5 to 7 exactly corresponds to the embodiment according to FIGS. 1 to 4.

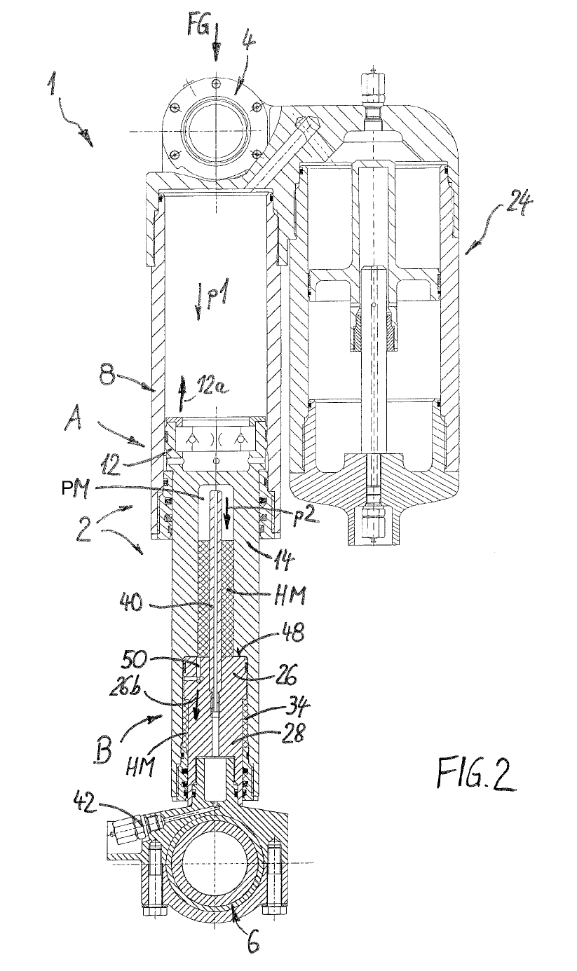

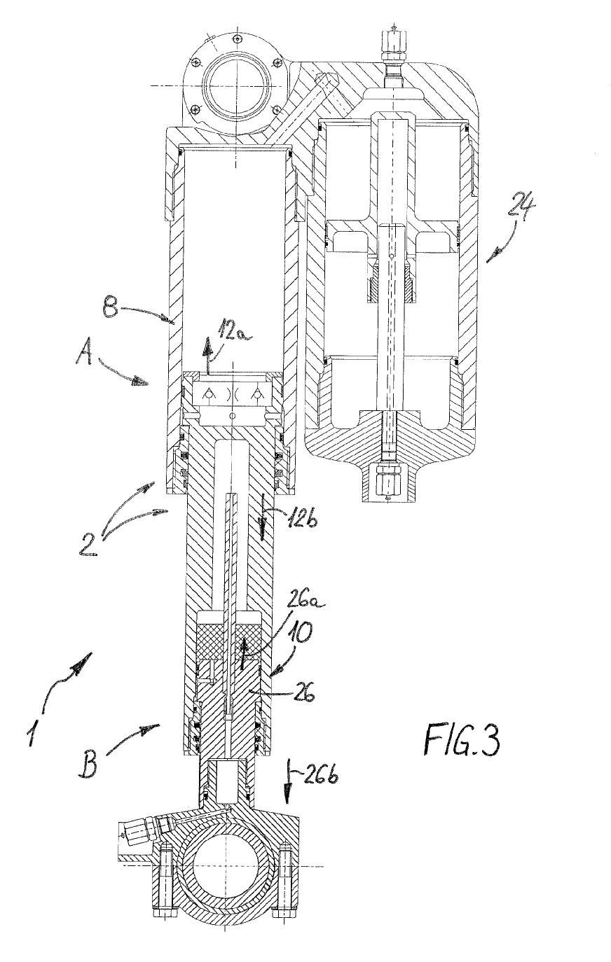

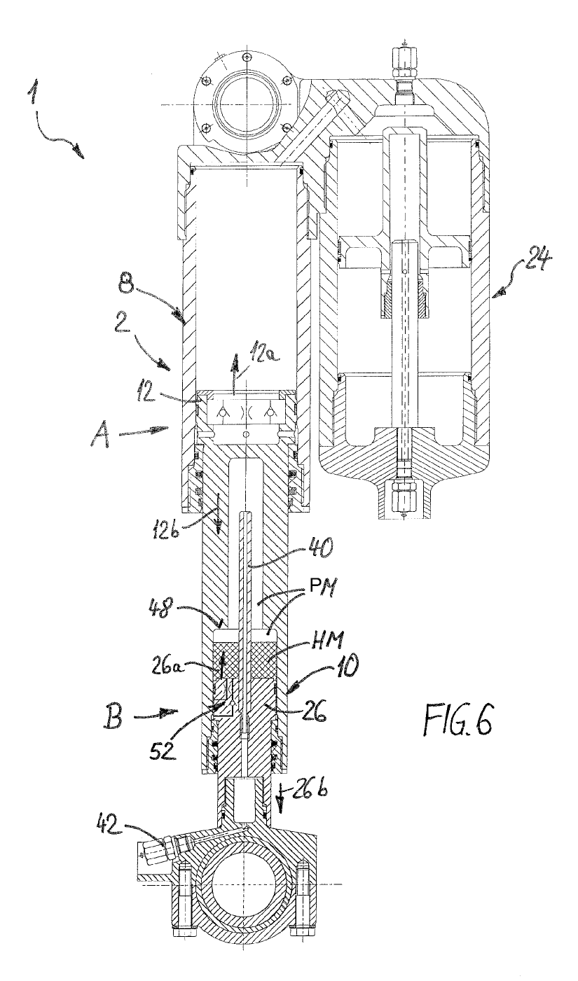

The illustrated, preferred embodiments further provide that the effective pressure—and area ratio in both spring steps A and B are designed as a function of an overall weight FG acting upon the spring cylinder 2 such that in a static state, only acted upon by the weight FG, the first spring stage A is in a decompressed end position on the one hand, and the second spring stage B is in a compressed end position on the other hand. This static position is shown for the first embodiment in FIG. 2 on the one hand, and for the second embodiment in FIG. 5 on the other hand. On the basis of this static position, there is a dynamic compression only in the area of the first spring stage A (arrow 12a) and a dynamic decompression only in the second spring stage B (arrow 26b). The decompressed end position at the maximum length of the spring cylinder 2 is respectively shown in FIGS. 3 and 6. In this decompressed end position, part of the volume of the pneumatic pressure medium PM can be arranged, as shown in the expanded area of the cylinder chamber 32 accommodating the auxiliary piston 26, in any case, however, above the hydraulic medium HM.

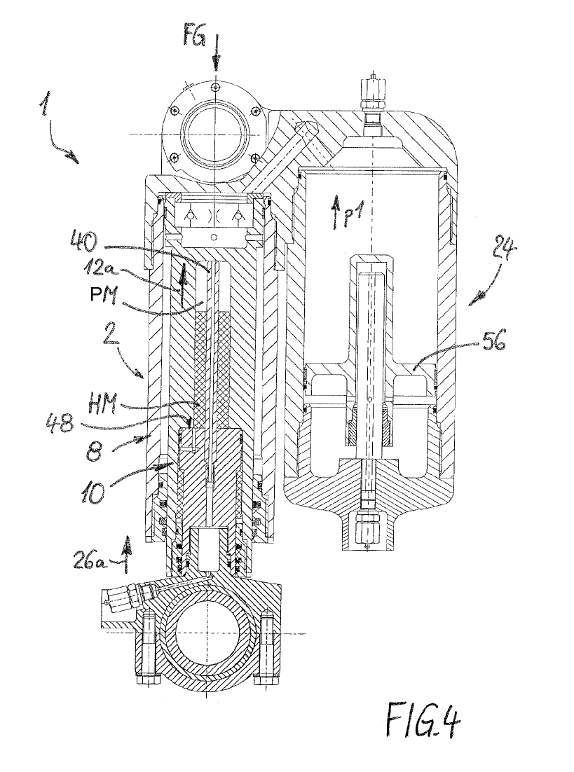

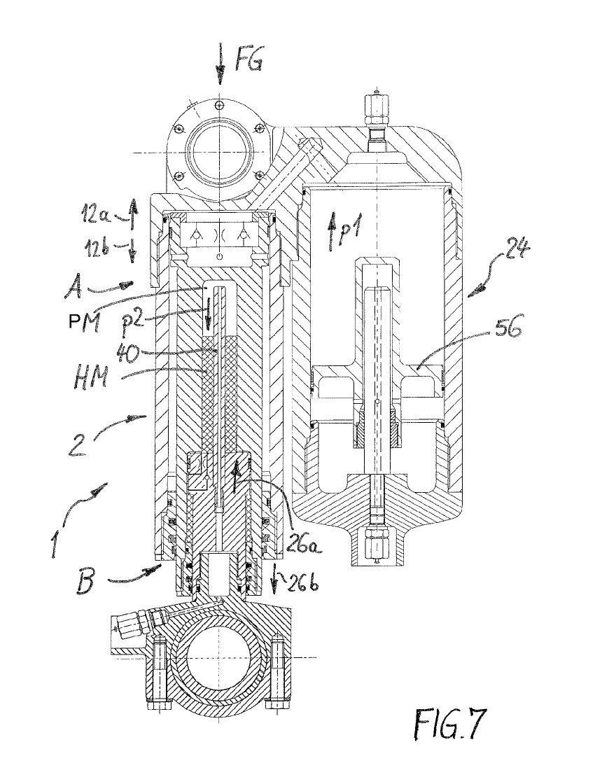

The maximum compressed end position at a minimally possible length of the spring cylinder 2 is respectively shown in FIGS. 4 and 7. In this preferred design of the special static position according to FIGS. 2 and 5, the position of both spring stages A, B shown in FIG. 1 cannot occur in practice because after a dynamic compression of the first stage A, this stage A is first fully decompressed to the static position before decompression can occur in stage B from the static position. The same is also conversely applicable to the process of dynamic decompression and subsequent compression from the static position.

As for the hydropneumatic pressure accumulator 24 that was only mentioned in general above, its concrete embodiment actually is not relevant to the present invention. However, the pressure accumulator 24 is preferentially configured as a piston accumulator that consists of an accumulator housing 54 and a dividing piston 56 floating in the accumulator housing and displaceable freely in the direction of an axis of motion. Said dividing piston 56 separates an accumulator chamber 58 from a pressure chamber 60 filled with a compressible medium. The accumulator chamber 58 is connected to the cylinder chamber 16 of the spring cylinder 2 and therefore is likewise filled with the hydraulic medium. The main piston 12 is thus indirectly acted upon via the hydraulic medium and the dividing piston 56 at a pressure p1 of the spring medium situated in the pressure chamber 60. In addition, in the illustrated embodiment, the dividing piston 56 is guided on a longitudinal axial guiding element 65 fastened inside the accumulator housing 54. With regard to this particular embodiment, reference is made to the European patent application EP 09168192. The pressure accumulator 24 is preferably mechanically and rigidly connected to the spring cylinder 2 and/or to the main cylinder 8, and arranged laterally parallel next to the main cylinder 8.

It should still be mentioned by way of example that the first spring stage A can be designed for an axial spring travel in the range of 270 to 350 mm, in particular 300 to 320 mm. The second spring stage B can be designed for a spring travel in the range of 50 to 80 mm, in particular 60 to 70 mm, which in practice is usually sufficient for the decompression thrust from the static position.

The invention is not limited to the illustrated and described exemplary embodiments but also comprises all equally acting embodiments along the lines of the invention. It is expressly stated that the exemplary embodiments are not limited to all combined characteristics; on the contrary, each partial characteristic can also be inventively important by itself independently of all other partial characteristics.

1. A suspension system (1) for a resilient wheel support for a motor vehicle comprising a linear telescopic spring cylinder (2) of variable length for compression and decompression purposes, having first and second spring stages (A, B) arranged longitudinally in series, with one main cylinder (8) as the first spring stage (A) and an auxiliary cylinder (10) as the second spring stage (B), an auxiliary piston (26) being guided by an auxiliary piston rod (28), and the auxiliary piston (26) inside the auxiliary cylinder (10) being acted upon by a spring pressure (p2) generated by an elastically compressible, pneumatic pressure medium (PM) contained at least proportionally in the auxiliary cylinder (10) for decompression, the auxiliary piston (26) is indirectly acted upon by the spring pressure (p2) via a hydraulic medium (HM) situated inside the auxiliary cylinder (10) in addition to the pneumatic pressure medium (PM), one or more peripheral seals (30, 38) arranged between the auxiliary cylinder (10) and the auxiliary piston (26) and between the auxiliary cylinder (10) the auxiliary piston rod (28), the one or more peripheral seals are separated from the pneumatic pressure medium (PM) via the hydraulic medium (HM).

2. The suspension system according to claim 1, further comprising in that the first spring stage (A) is arranged in an upper vertical area of the spring cylinder (2) and the second spring stage (B) is arranged when the cylinder (2) is mounted to the motor vehicle in a lower vertical area of the spring cylinder (2).

3. The suspension system according to claim 2, further comprising in that inside the auxiliary cylinder (10) there is arranged a filling pipe (40) and an upper end (40a) thereof extends axially through the hydraulic medium (HM) situated in a lower area due to gravity, and further extends into the area of the pneumatic pressure medium (PM) situated above the hydraulic medium (HM), wherein a lower end (40b) of the filling pipe (40) merges into the filling connector (42) present in the lower area of the spring cylinder (2).

4. The suspension system according to claim 2, further comprising in that the auxiliary cylinder (10) forming the second spring stage (B) is aligned such that the auxiliary cylinder (10) faces the upper, first spring stage (A), the auxiliary piston rod (28) extending downward from the auxiliary cylinder and being connected in its free lower area to a lower mounting element (6) for a vehicle-side holding connection.

5. The suspension system according to claim 3, further comprising in that the auxiliary piston rod (28) and the auxiliary piston (26) has an inner filling channel (44) starting at the filling connector (42) and merging into the filling pipe (40) arranged on the side of the auxiliary piston (26).

6. A suspension system according to claim 1 further comprising in that an annular step (48) is formed as a jounce bumper for the auxiliary piston (26) due to a reduction of the inner cross-section inside the auxiliary cylinder (10).

7. A suspension system according to claim 1 further comprising in that the auxiliary piston (26) inside the auxiliary cylinder (10) separates two working chambers (32, 34) from one another, with a cylinder chamber (32) facing the pneumatic pressure medium (PM) from an annular chamber enclosing the auxiliary piston rod (28), both working chambers (32, 34) being hydraulically connected via a passage (50) passing through the auxiliary piston (26) or via a hydraulic damping valve arrangement (52).

8. A suspension system according to claim 2 further comprising in that the main cylinder (8) forming the first spring stage (A) is arranged in the upper vertical area of the spring cylinder (2), a main piston (12) for compression and decompression purposes being displaceable in the main cylinder (8) and connected to a main piston rod (14) protruding downward from the main cylinder (8).

9. The suspension system according to claim 8, further comprising in that the main piston rod (14) in the area of the free lower end thereof is connected to the auxiliary cylinder (10), or due to a hollow formation starting at the free lower end thereof, the main piston rod is the auxiliary cylinder (10) directly accommodating the auxiliary piston (26) with the auxiliary piston rod (28).

10. The suspension system according to claim 8 further comprising in that the main piston (12) inside the main cylinder (8) separates from one another two working chambers (16, 18) filled with the hydraulic medium, with an upper cylinder chamber (16) from an annular chamber (18) enclosing the main piston rod (14), the working chambers (16, 18) being hydraulically connected to one another, via a damping valve arrangement (22).

11. The suspension system according to claim 10, characterized in that the main piston (12) is acted upon by a spring pressure (p1) of a hydropneumatic pressure accumulator (24) for decompression, the cylinder chamber (16) being hydraulically connected to the pressure accumulator (24) for this purpose.

12. A suspension system according to claim 1, further comprising by a design of the effective pressure- and area ratio of both spring stages (A, B) adapted to a weight (FG) acting upon the spring cylinder (2) such that in a static position acted upon by the weight (FG), the first spring stage (A) is in the decompressed position, and additionally the second spring stage (B) is in a compressed end position, so that starting at the static position, the dynamic compression only occurs at the first spring stage (A) while the dynamic decompression only occurs at the second spring stage (B).
